(19) United States
(12) Patent Application Publication
(10) Pub. No.: US 2008/0106179 A1
(43) Pub. Date: May 8, 2008

(54) FLAT LIGHT MODULE AND MANUFACTURING METHOD THEREOF

(75) Inventors: CHAO-JEN CHANG, TAOYUAN (TW); CHENG-KAI HSU, TAOYUAN (TW); CHIA-HUA AI, TAOYUAN (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., TAOYUAN (TW)

(21) Appl. No.: 11/756,089

(22) Filed: May 31, 2007

(30) Foreign Application Priority Data
Nov. 3, 2006 (TW) 95140758

(51) Int. Cl. H01J 1/66; H01J 9/22

(52) U.S. Cl. 313/485; 445/11

(57) ABSTRACT

A flat light module and the manufacturing method thereof are disclosed. A first substrate and a second substrate with a plurality of electrodes are assembled. The discharge gas is filled between both substrates. A first dielectric layer with a first pattern and a second dielectric layer with a second pattern are covered on the electrodes in order, wherein the first pattern is used as a stopper and the second pattern is used as a mask to remove a portion of the second dielectric layer to form a plurality of protrusions and to expose a portion of surface of the second dielectric layer. Next, the first pattern and the second pattern are removed to expose a portion of surface of the first dielectric layer and the second dielectric layer, and then a fluorescent layer is coated on the exposed surfaces, the upper surface of the second substrate except for the surface of forming the electrodes and the first dielectric layer. The manufacturing method of the flat light module can simplify the manufacturing process and reduce the manufacturing time and cost.

### BACKGROUND OF THE INVENTION

1. Field of the Invention

The present invention relates to the flat light module and the manufacturing method thereof, and more especially, to the flat light module with a high light-emitting efficiency and the manufacturing method thereof.

2. Background of the Related Art

The flat backlight module is widely used as the illuminant for the flat panel display (FPD) because it can provide extensive plane light source and has a high light-emitting efficiency with good uniformity. A conventional flat light module includes an upper substrate and a lower substrate. A plurality of metal electrodes are formed on the lower substrate and then a dielectric layer is formed on the lower substrate to cover the metal electrodes. The fluorescent layers are formed on the upper surface of the dielectric layer and the lower surface of the upper substrate. A plurality of ribs are formed between the upper and the lower substrates, and discharge gas is filled between the upper and lower substrates. When a voltage is applied on the metal electrodes to generate an electrical field, the discharge gas is ionized by the electrical field to form plasma and then emits ultraviolet rays. The ultraviolet rays stimulate and excite the fluorescent layers to emit white light.

The dielectric layer abovementioned has a flat plane surface, which limits light-emitting area and reduces light-emitting efficiency because it utilizes only the fluorescent layer coated on the flat plane surface of the dielectric layer. Another conventional dielectric layer is patterned as a plane surface with a plurality of bars which are the same height, and every bar structure covers a metal electrode respectively. For the patterned dielectric layer, the fluorescent layer is coated on the plane surface and the sidewall surface of the bar to increase the light-emitting area, but it still can not satisfy the requirement of high light-emitting efficiency. Besides, utilizing a conventional multilayer printing technology, which includes many complex and repeated processes, to pattern the dielectric layer increases the manufacturing time and cost.

### SUMMARY OF THE INVENTION

One object of the present invention is to provide a flat light module and the manufacturing method thereof, wherein the flat light module has a various height dielectric structure formed by the screen printing/coating, exposing, developing and sand blasting/etching technologies to simplify the manufacturing process and reduce the manufacturing time and cost.

One object of the present invention is to provide a flat light module having a dielectric structure with a various height to enhance the light-emitting efficiency by increasing the coated area of the fluorescent layer.

One object of the present invention is to provide a flat light module that the non-discharge gaps thereof begin illuminating due to the cross-talk induced by the fluorescent material coated on the cavities of the dielectric structure.

One object of the present invention is to provide a flat light module to simplify the manufacturing process, and economize the manufacturing material by replacing ribs with dielectric structures.

In order to achieve the above objects, one embodiment of the present invention provides a flat light module manufacturing method including: providing a first substrate, a second substrate paralleled the first substrate and forming a plurality of electrodes on the upper surface of the second substrate; forming a first dielectric layer to cover the electrodes; forming a first photoresist film on the first dielectric layer and patterning the first photoresist film on a first pattern by using a photolithography process; forming a second dielectric layer on the first dielectric layer to cover the first pattern; forming a second photoresist film on the second dielectric layer and patterning the second photoresist film on a second pattern by using a photolithography process; using the first pattern as a stopper and using the second pattern as a mask to remove a portion of the second dielectric layer to form a plurality of protrusions, and to expose a portion of surface of the second dielectric layer; removing the first pattern and the second pattern to expose a portion of surface of the first dielectric layer and the second dielectric layer; coating a fluorescent layer on the exposed surfaces of the first dielectric layer and the second dielectric layer, and the upper surface of the second substrate except for the surface of forming the electrodes and the first dielectric layer; and filling discharge gas between the first substrate and the second substrate.

Another embodiment of the present invention provides a flat light module which includes: a first substrate; a second substrate paralleled the first substrate; a plurality of electrodes formed on the upper surface of the second substrate; a plurality of dielectric structures formed on the upper surface of the second substrate, wherein every dielectric structure is configured to cover one of those electrodes, and a plurality of protrusions are formed on the upper surface of each dielectric structure; a fluorescent layer coated on the exposed surface of the dielectric structures, and the upper surface of the second substrate except for the surface forming the electrodes and the first dielectric layer; and discharge gas filled between the first substrate and the second substrate.

### BRIEF DESCRIPTION OF THE DRAWINGS

FIG. 1a to FIG. 1f are the schematic cross-sectional diagrams to illustrate the process flow for manufacturing a dielectric structure of a flat light module in accordance with an embodiment of the present invention.

FIG. 2 is a schematic cross-sectional diagram of a flat light module in accordance with one embodiment of the present invention.

FIG. 3 is a side-view diagram of a dielectric structure in accordance with one embodiment of the present invention.

FIG. 4 is a schematic cross-sectional diagram of a flat light module in accordance with another embodiment of the present invention.

### DETAILED DESCRIPTION OF THE INVENTION

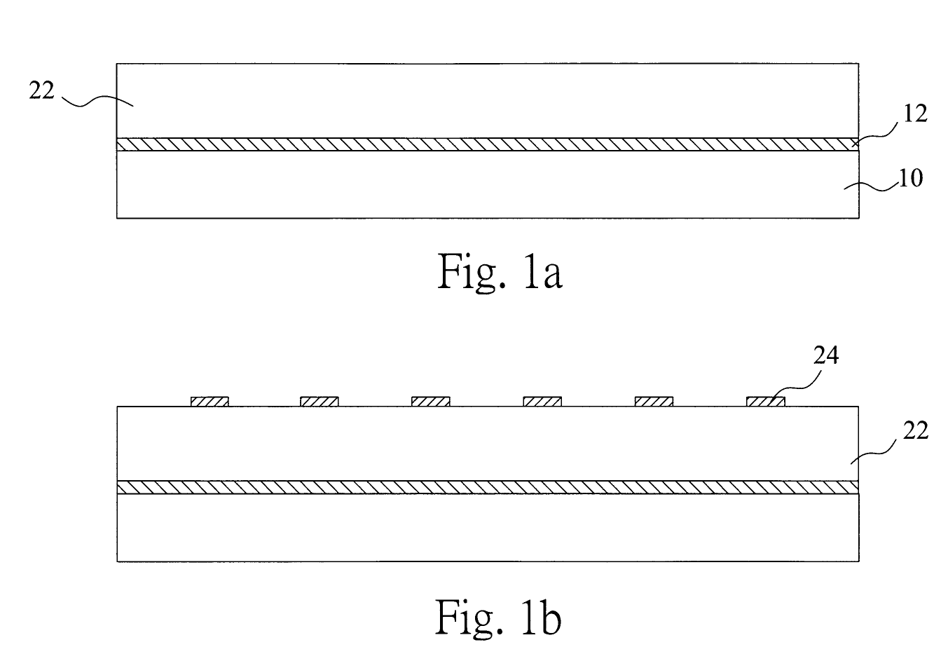

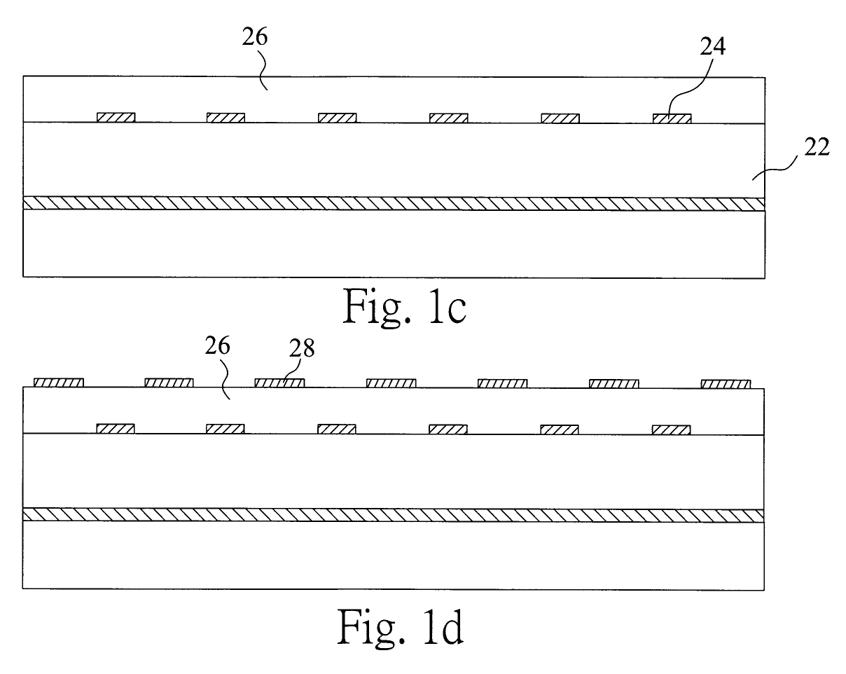

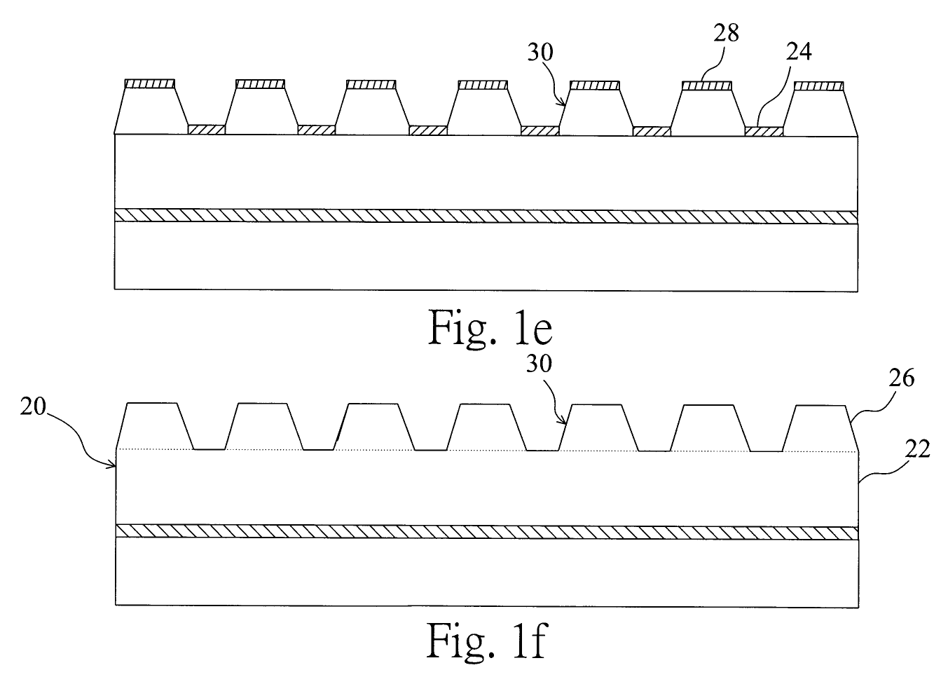

FIG. 1a to FIG. 1f are the schematic cross-sectional diagrams to illustrate the process flow for manufacturing a various height dielectric structure of a flat light module in accordance with an embodiment of the present invention. First, referring to FIG. 1a, a substrate 10 with metal electrodes 12 formed thereon by any suitable manufacturing method is provided, and a first dielectric layer 22 is formed on the upper surface of the substrate 10 by performing a screen printing process or a coating process. Next, referring to FIG. 1b, the first dielectric layer 22 is covered by a first dry photoresist film and then the first dry photoresist film is pattern-transferred, exposed and developed to form a first pattern 24. Next, referring to FIG. 1c, a second dielectric layer 26 is formed on the first dielectric layer 22 to cover the first pattern 24 by performing a screen-printing process or a coating process. Next, referring to FIG. 1d, a second dry photoresist film is formed on the second dielectric layer 26 and then the second dry photoresist film is pattern-transferred, exposed and developed to form a second pattern 28, wherein the second pattern 28 and the first pattern 24 are not overlapped in the vertical direction. Next, referring to FIG. 1e, the first pattern 24 is used as a stopper and the second patterns 28 is used as a mask to remove a portion of the second dielectric layer 26 by performing a sand blasting process or an etching process, wherein the portion of the second dielectric layer 26 masked by the second pattern 28 is retained to form a plurality of protrusions 30, and the portion of the surface of the second dielectric layer is exposed. Finally, referring to FIG. 1f, the first pattern 24 and the second pattern 28 are removed by a solution of weak alkaline aqueous solution to expose a portion of surface of the first dielectric layer and the second dielectric layer, and then the first dielectric layer 22 and the second dielectric layer 26 will combine as a dielectric structure 20 with the protrusions 30.

The foregoing manufacturing method using the screen printing/coating, exposing, developing and sand blasting/etching technologies to form the protrusions has the advantages of simple manufacturing process and short manufacturing time. Therefore, comparing with the protrusions formed by conventional multilayer printing technology that needs many complex and repeated processes, the present invention can simplify the manufacturing process and reduce the manufacturing cost.

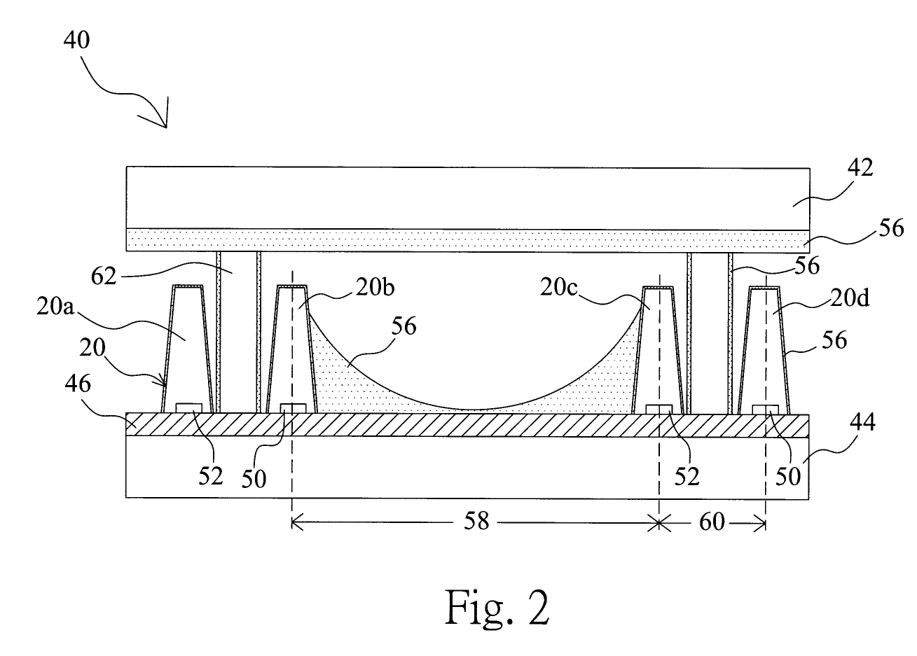

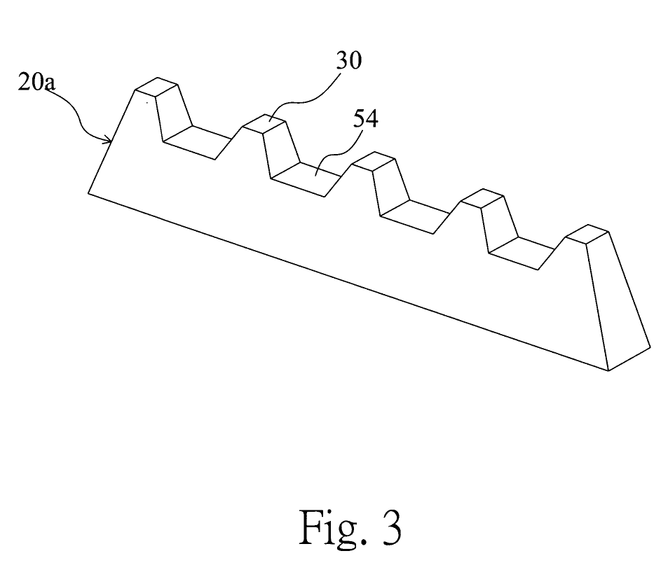

FIG. 2 is a schematic cross-sectional diagram of a flat light module in accordance with an embodiment of the present invention. A flat light module 40 includes a first substrate 42 and a second substrate 44, and both substrates are made of glass. The first substrate 42 and the second substrate 44 are parallel to each other and separated by a distance to accommodate the discharge gas (not shown in FIG. 2). The discharge gas is an inert gas generally. A reflection layer 46 is formed on the second substrate 44, and a plurality of metal electrode pairs are formed on the surface of the reflection layer 46. Every metal electrode pair includes a positive electrode 50 and a negative electrode 52. A plurality of dielectric structures 20 are formed on the reflection layer 46. The arrangements of the dielectric structures 20 are parallel, and every dielectric structure 20 respectively covers one of the electrodes 50, 52 to protect and isolate the electrodes 50, 52. For illustrating the dielectric structures 20 clearly, 20a, 20b, 20c, 20d represent four dielectric structures 20 in FIG. 2. Please referring to FIG. 3 simultaneously, it is a side-view diagram of single dielectric structure 20a, wherein the FIG. 3 shows a plurality of protrusions 30 formed on the upper surface of every dielectric structure 20a, and a cavity 54 accompanied between two adjacent protrusions 30. As same to the dielectric 20a, the dielectric structures 20b, 20c, 20d have also the protrusions 30 on their upper surface. A fluorescent layer 56 is coated on the lower surface of the first substrate 42, the upper surface of the reflection layer 46 except for the surface forming the positive electrodes 50, the negative electrodes 52 and the dielectric structure 20, and the exposed surface of every dielectric structure 20, wherein the exposed surface includes the sidewall surface of the dielectric structure 20, the outer surface of the protrusions 30 and the inner surface of the cavity 54.

Furthermore, the space between the positive electrode 50 and the negative electrode 52 of every metal electrode pair is defined as a discharge gap 58, and the space between two adjacent metal electrode pairs is defined as a non-discharge gap 60. A plurality of ribs 62 are formed between the first and second substrates 42, 44 to maintain the constant distance of the space between the first and second substrates 42, 44. Every rib 62 is formed in the non-discharge gap 60, and the sidewalls of the rib 62 are also coated with the fluorescent layer 56. When a voltage applied on the positive electrode 50 and the negative electrode 52 to form an electric field, the discharge gas is ionized by the electrical field to form plasma and then emits ultraviolet rays. The ultraviolet rays irradiate and excite the entire fluorescent layer 56 to emit the white light. At the same time, the cross-talk is induced in the cavities of the dielectric structure 20, and makes the non-discharge gap 60 illuminate.

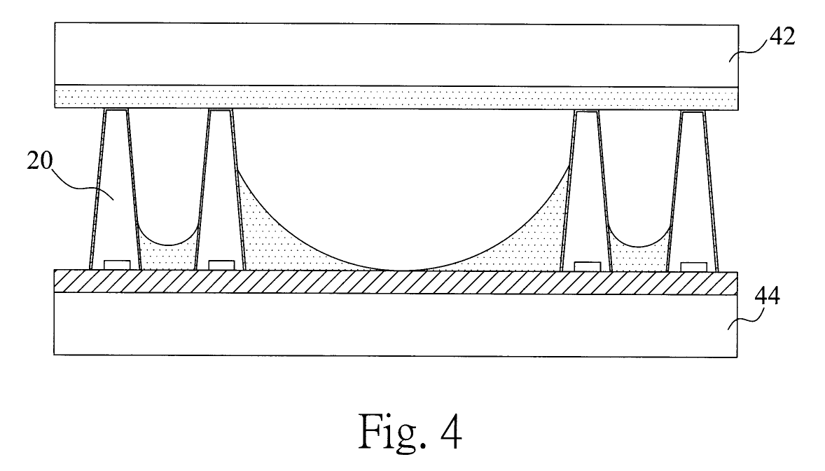

FIG. 4 is a schematic cross-sectional diagram of a flat light module in accordance with another embodiment of the present invention. The dielectric structure 20, which is elongated to contact the first substrate 42, replaces the ribs 62 shown in FIG. 3. Directly using the dielectric structure 20 to maintain the constant distance of the space between the first and the second substrates 42, 44 has the advantages of simplifying the manufacturing process, economizing the material and reducing the cost.

To sum up, utilizing protrusions and cavities of the dielectric structures increase surface area of the fluorescent layer and enhance the illuminating efficiency. Moreover, the cavities of the dielectric structures generate a cross-talk stimulating the non-discharge gaps luminesce, and the increasing brightness of the flat light module is 25˜30%.

Although the present invention has been explained in relation to its preferred embodiment, it is to be understood that other modifications and variation can be made without departing the spirit and scope of the invention as hereafter claimed.

What is claimed is:

1. A manufacturing method of a flat light module, comprising:
providing a first substrate and a second substrate opposite to each other;
forming a plurality of electrodes on an upper surface of the second substrate;
forming a first dielectric layer to cover the electrodes;
forming a first photoresist film on the first dielectric layer and patterning the first photoresist film on a first pattern by using a photolithography process;
forming a second dielectric layer on the first dielectric layer to cover the first pattern;
forming a second photoresist film on the second dielectric layer and patterning the second photoresist film on a second pattern by using a photolithography process;
using the first pattern as a stopper and using the second pattern as a mask to remove a portion of the second dielectric layer to form a plurality of protrusions, and to expose a portion of surface of the second dielectric layer; removing the first pattern and the second pattern to expose a portion of surface of the first dielectric layer and the second dielectric layer;
coating a fluorescent layer on the exposed surfaces of the first dielectric layer and the second dielectric layer, and the upper surface of the second substrate except for the surface of forming the electrodes and the first dielectric layer; and
filling discharge gas between the first substrate and the second substrate.

2. The manufacturing method of a flat light module according to claim 1, wherein the first dielectric layer is formed by performing a screen printing process or a coating process.

3. The manufacturing method of a flat light module according to claim 1, wherein the second dielectric layer is formed by performing a screen printing process or a coating process.

4. The manufacturing method of a flat light module according to claim 1, wherein a sand blasting process is used to remove a portion of the second dielectric layer.

5. The manufacturing method of a flat light module according to claim 1, wherein an etching process is used to remove a portion of the second dielectric layer.

6. The manufacturing method of a flat light module according to claim 1, wherein the first photoresist film is a dry photoresist film.

7. The manufacturing method of a flat light module according to claim 1, wherein the second photoresist film is a dry photoresist film.

8. A flat light module, comprising:
a first substrate;
a second substrate disposed opposite to the first substrate;
a plurality of electrodes formed on the upper surface of the second substrate;
a plurality of dielectric structures formed on the upper surface of the second substrate, wherein every the dielectric structure is configured to cover one of the electrodes, and a plurality of protrusions are formed on the upper surface of each of the dielectric structures;
a fluorescent layer coated on the exposed surface of the dielectric structures and the upper surface of the second substrate except for the surface of forming the electrodes and the dielectric structures; and
a discharge gas filled between the first substrate and the second substrate.

9. The flat light module according to claim 8, wherein the fluorescent layer is also coated on the lower surface of the first substrate.

10. The flat light module according to claim 8, wherein a reflection layer is set between the second substrate and the electrodes.

11. The flat light module according to claim 8, wherein the electrodes are metallic electrodes.

12. The flat light module according to claim 8, wherein a plurality of ribs are formed between the first substrate and the second substrate, and the fluorescent layer is also coated on the sidewalls of the ribs.

13. The flat light module according to claim 8, wherein the dielectric structures are elongated to contact the first substrate.

14. The flat light module according to claim 8, wherein the first substrate and the second substrate are made of glass.

15. The flat light module according to claim 8, wherein the discharge gas is an inert gas.
